(19) United States
(12) Patent Application Publication
(10) Pub. No.: US 2019/0042652 A1
(43) Pub. Date: Feb. 7, 2019

(54) SYSTEMS AND METHODS FOR IMPROVING SEARCH RESULTS THROUGH PARTIAL SELECTION OF AN INITIAL RESULT

(71) Applicant: CareerBuilder, LLC, Chicago, IL (US)

(72) Inventor: Jakub Zavrel, Amsterdam (NL)

(21) Appl. No.: 15/667,470

(22) Filed: Aug. 2, 2017

(51) Int. Cl. G06F 17/30; G06Q 10/10

(52) U.S. Cl. CPC G06F 17/30867; G06Q 10/10; G06Q 10/1053; G06F 17/30522

(57) ABSTRACT

Methods and apparatus are disclosed for systems and methods for improving search results through partial selection of an initial result. An example system includes a query manager to present candidate information to a recruiter based on a search term list during a session on an employment website and modify the search term list to include a first search term selected by the recruiter. The query manager also is to query a database for a list of candidates based on the search term list that is modified and present the list of candidates on the employment website during the session. The example system includes a search term generator to identify a first portion of the candidate information that has been highlighted by the recruiter on the employment website and automatically convert the first portion of the candidate information into the first search term responsive to the recruiter highlighting the first portion.

### TECHNICAL FIELD

The present disclosure generally relates to search results and, more specifically, to systems and methods for improving search results through partial selection of an initial result.

### BACKGROUND

Typically, employment websites (e.g., CareerBuilder.com®) are utilized by employers and job seekers. Oftentimes, an employment website incorporates a job board on which employers may post positions they are seeking to fill. In some instances, the job board enables an employer to include duties of a position and/or desired or required qualifications of job seekers for the position. Additionally, the employment website may enable a job seeker to search through positions posted on the job board. If the job seeker identifies a position of interest, the employment website may provide an application to the job seeker for the job seeker to fill out and submit to the employer via the employment website. Further, in some instances, the employment website enables an employer to search through profiles, resumes, and/or other information that job seekers have submitted to the employment website. If the employer identifies a job seeker for an open position, the employment website may facilitate the employer in contacting the job seeker for future employment.

An employment website may attract thousands of job seekers to submit their profiles, resumes, and/or other information, thereby making it difficult for an employer to identify job seekers of interest for an open position. Oftentimes, an employment website include search tool(s) that allow an employer to create a list or string of search terms that are utilized to search for and identify job seekers of interest within the employment website. In some instances, a search requires a number of selections by the employer before a new search term is created and added to the list or string of search terms. As a result, an employer may inefficiently spend time revising a list of search terms and/or may lose his or her train of thought while attempting to navigate the search tool(s) of the employment website. Thus, there is a need for a user-friendly search tool of an interface that assists an employer in quickly and intuitively adding one or more search terms to a list or string of search terms utilized for identifying job seekers of interest within an employment website.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for systems and methods for improving search results through partial selection of an initial result. An example disclosed system for adjusting search queries for candidates on employment websites includes a query manager to present, via a processor, candidate information to a recruiter based on a search term list during a session on an employment website and modify, in real time during the session, the search term list to include a first search term selected by the recruiter. The query manager also is to query, in real time during the session, a database for a list of candidates based on the search term list that is modified and present the list of candidates on the employment website during the session. The example disclosed system also includes a search term generator to identify a first portion of the candidate information that has been highlighted by the recruiter on the employment website and automatically convert the first portion of the candidate information into the first search term responsive to the recruiter highlighting the first portion.

An example disclosed method for adjusting search queries for candidates on employment websites includes presenting, via a processor, candidate information to a recruiter based on a search term list during a session on an employment website and identifying, via the processor, a first portion of the candidate information responsive to the recruiter highlighting the first portion on the employment website. The example disclosed method also includes automatically converting, via the processor, the first portion of the candidate information that has been highlighted by the recruiter into a first search term and modifying, in real time during the session, the search term list to include the first search term. The example disclosed method also includes querying, in real time during the session, a database for a list of candidates based on the search term list that is modified and presenting the list of candidates on the employment website during the session.

An example disclosed tangible computer readable medium includes instructions which, when executed, cause a machine to present candidate information to a recruiter based on a search term list during a session on an employment website, identify a first portion of the candidate information Syresponsive to the recruiter highlighting the first portion on the employment website, and automatically convert the first portion of the candidate information that has been highlighted by the recruiter into a first search term. The instructions which, when executed, also cause the machine to modify, in real time during the session, the search term list to include the first search term and query, in real time during the session, a database for a list of candidates based on the search term list that is modified. The instructions which, when executed, also cause the machine to present the list of candidates on the employment website during the session.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example employment website entity that modifies a query for candidate information based on search term(s) that are highlighted by a recruiter on an employment website.

FIG. 2 illustrates an example interface of the employment website of FIG. 1.

FIG. 3 illustrates another example interface of the employment website of FIG. 1.

FIG. 4 illustrates another example interface of the employment website of FIG. 1.

FIG. 5 illustrates another example interface of the employment website of FIG. 1.

FIG. 6 illustrates another example interface of the employment website of FIG. 1.

FIG. 7 illustrates another example interface of the employment website of FIG. 1.

FIG. 8 illustrates another example interface of the employment website of FIG. 1.

FIG. 9 illustrates another example interface of the employment website of FIG. 1.

FIG. 10 is a block diagram of electronic components of the employment website entity of FIG. 1.

FIG. 11 is a flowchart of example method to modify a query based on candidate information that is highlighted by a recruiter on an employment website.

FIG. 12 is a flowchart of example method to generate search terms based on the highlighted candidate information of FIG. 11.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

The example methods and apparatus disclosed herein include an employment website which, in real time during a session of a recruiter on an employment website, presents candidate information to the recruiter based on a search term list, identifies a portion of the candidate information that the recruiter has highlighted on the employment website, automatically converts the highlighted portion into a search term, modifies the search term list to include the search term, queries a database for a list of candidates based on the modified search term list, and presents the list of candidates on the employment website. Thus, the examples disclosed herein provide an unconventional technical solution of automatically creating a new search term and adding the new search term to a search term list based upon text of an employment website that is highlighted by a user. The new search term is automatically created based upon the text that is highlighted by the user on the employment website to enable the user to quickly and intuitively revise a search for candidates on the employment website. Further, examples disclosed herein enable the recruiter to add a new search term to a search term list by a highlighting a portion of a profile summary within a list of candidates, an expanded profile summary, a candidate profile and/or a resume that is presented to the recruiter via the employment website to enable the user to quickly and intuitively revise the search for candidates on the employment website. Examples disclosed herein also enable the recruiter to classify the new search term (e.g., as an additional search term, a filter, a negative filter, or other search term type) to further enable the user to quickly and intuitively revise a search for candidates on the employment website.

Examples disclosed herein include systems for adjusting search queries for candidates on employment websites. As used herein, a “candidate” and a “job seeker” refer to a person who is searching for a job, position, and/or career. As used herein, an “employment website” refers to a website and/or any other online service (e.g., an app) that facilitates job placement, career, and/or hiring searches. Example employment websites include CareerBuilder.com®, Sologig.com®, etc. As used herein, an “employment website entity” refers to a person, a partnership, an organization, a company, a subsidiary, another entity, and/or any combination thereof that owns and/or operates an employment website. An example employment website entity includes CareerBuilder®.

The example systems disclosed herein include a query manager that presents, via a processor, candidate information to a recruiter based on a search term list during a session on an employment website. As used herein, “candidate information” refers to contact information, qualification information, and/or employment preference information of one or more candidates. Candidate information of a candidate may be submitted to an employment website entity by the candidate via an employment website and/or otherwise collected by the employment website entity. Additionally or alternatively, candidate information may be presented by an employment website to a recruiter within a profile summary, an expanded profile summary, a profile, a resume, and/or a list of candidates. As used herein, a “recruiter” refers to a person and/or entity (e.g., an employer such as a company, a corporation, etc.) that is soliciting and/or looking to hire one or more candidates for a position and/or a job. As used herein, a “session” refers to an interaction between a job seeker and an employment website. Typically, a session will be relatively continuous from a start point to an end point. For example, a session may begin when the candidate opens and/or logs onto the employment website and may end when the candidate closes and/of logs off of the employment website.

In some examples, the candidate information presented by the query manager is included in an initial list of candidates that the query manager identifies based on an initial search term that is included in the search term list. For example, the query manager receives the initial search term via a search box of the employment website. That is, the query manager receives the initial search term upon the recruiter entering the initial search term into the search box of the employment website. Further, the search box of the employment website in examples disclosed herein enables the query manager to receive other search term(s) from the recruiter throughout the recruiter's session on the employment website.

As used herein, a “search box,” a “search bar,” and a “search field” refer to an element of an employment website that receives a search term and/or other input from a user (e.g., a recruiter, a candidate) of an employment website. For example, a user types a search term into a search box of an employment website to submit a search term to the employment website. In some examples, a search box presents a search term that is audibly received from a user (e.g., via speech recognition software).

Further, the example systems disclosed herein include a search term generator that identifies a first portion of the presented candidate information that has been highlighted by the recruiter on the employment website. In some examples, the first portion of the candidate information that is highlighted by the recruiter includes a profession, an employment title, a number of years of work experience, an education level, an educational degree, a location, a skill set of the candidate, and/or any other qualification information and/or employment preferences information of candidates.

As used herein, to “highlight” refers to selecting text and/or information presented via an interface of a website and/or an app to cause the selected text and/or information to stand out within the interface (e.g., by changing the color of the text and/or an area of a background surrounding the text). Hypertext (i.e., text that directs a user to other text upon selection) and non-hypertext (i.e., text that does not direct a user to other text) may be highlighted by a user within an interface. In some examples, a user highlights a word or phrase presented via an interface of a website and/or an app by double-clicking on and/or by clicking and dragging over the word or phrase utilizing a mouse, a touchpad, and/or other input device of a computer. In examples in which an interface of a website and/or an app is presented via a touchscreen, a user may highlight a word or phrase presented via an interface of a website and/or an app by double-tapping a portion of the touchscreen that corresponds with the word or phrase and/or by tapping, holding and dragging his or her finger over the portion of the touchscreen that corresponds with the word or phrase. As used herein, “highlighted” text and/or information refers to a word or phrase presented via an interface of a website and/or an app that stands out (e.g., via a text color and/or a color of a background surrounding the text) within the interface upon being selected by a user of the website and/or the app. For example, a highlighted word or phrase stand out relative to other word(s) or phrase(s) that are not highlighted.

The search term generator of the examples disclosed herein also automatically converts the first portion of the candidate information into a first search term responsive to the recruiter highlighting the first portion. As used herein, a “search term” refers to a word, a term, and/or a phrase that is utilized to search for, identify, and retrieve a list of one or more candidate(s) and/or candidate information of the one or more candidate(s). Example search terms include additional search terms (i.e., logical disjunctions, “or” operators), filters (e.g., logical conjunctions, “and” operators), and/or negative filters (e.g., logical negations, “not” operators). As used herein, to “convert” text and/or information refers to generating a search term that is added to a list and/or string of search terms based upon text (e.g., non-hypertext) presented within an employment website that is highlighted by a user of the employment website.

In some examples, the first search term automatically generated by the search term generator is (i.e., is identical to) the first portion of the candidate information that is highlighted. In other examples, the search term generator converts the first portion of the candidate information to a synonym, a related term, and/or a different grammatical structure of the first portion to generate the first search term. For example, the search term generator stems one or more words of the highlighted first portion to convert the first portion of the candidate information into the first search term. As used herein, to “stem” and to “perform word normalization” refer to processes in which a word and/or one or more words of a phrase may be changed to its word stem, root, or base. For example, each of the words “performs,” “performed,” and/or “performing” might be transformed to “perform.”

Additionally, the query manager of the examples disclosed herein modifies, in real time during the session, the search term list to include the first search term selected by the recruiter. The query manager also queries, in real time during the session, a database for a list of candidates based on the search term list that is modified and present the list of candidates on the employment website during the session. As used herein, “real time” refers to a time period that is simultaneous to and/or immediately after a candidate enters a keyword into an employment website. For example, real time includes a time duration before a session of the candidate with an employment app ends.

Further, in some examples, the search term generator identifies a second portion of the candidate information that has been highlighted by the recruiter during the session and automatically converts the second portion of the candidate information into a second search term responsive to the recruiter highlighting the second portion. In such examples, the query manager modifies, in real time during the session, the search term list to include the second search term selected by the recruiter.

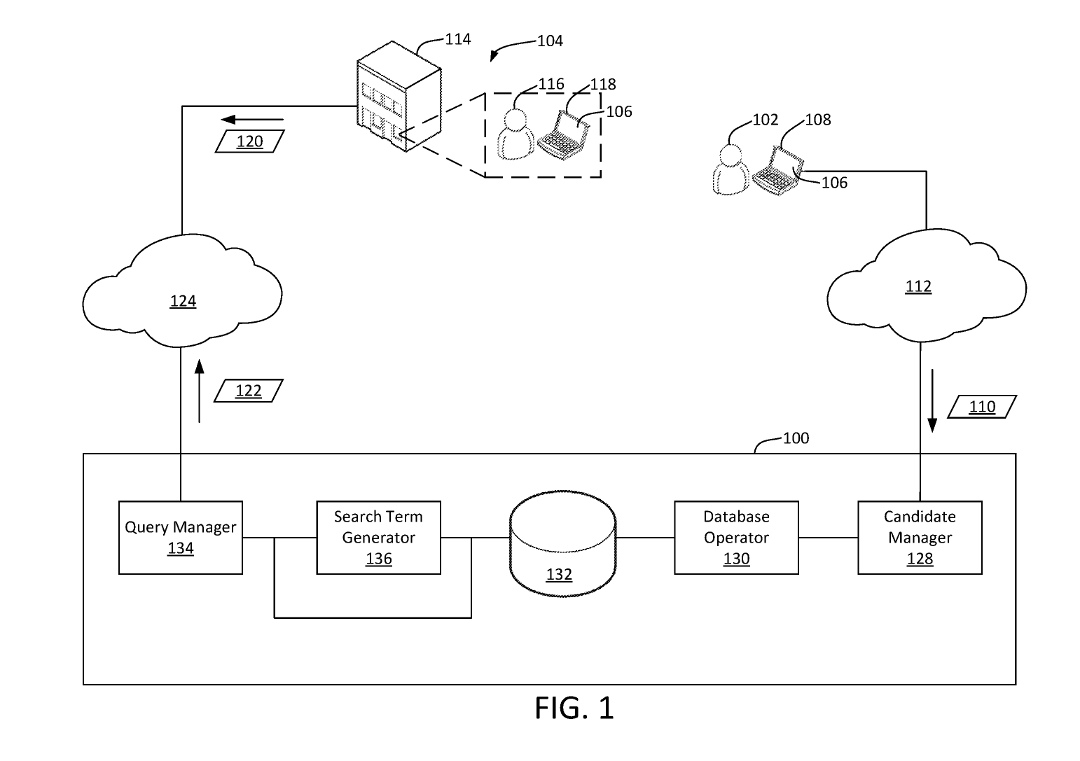

Turning to the figures, FIG. 1 illustrates an example employment website entity 100 (e.g., CareerBuilder.com®) in communication with a candidate 102 and a recruiter 104 via an employment website 106. For example, the employment website 106 enables the candidate 102 to search for employment opportunities and submit applications for employment opportunities of interest. Further, the employment website 106 enables the recruiter 104 to search for, identify, and contact candidates of interest for potential employment opportunities.

In the illustrated example, the candidate 102 utilizes a computer 108 (e.g., a desktop, a laptop, a mobile device such as a smart phone, a tablet, a smart watch, a wearable, etc.) to interact with the employment website 106 of the employment website entity 100. The candidate 102 interacts with the employment website 106 during a session of the candidate 102 on the employment website 106. For example, the employment website 106 presents information (e.g., prompts, employment opportunities, descriptions of employment opportunities, requirements for employment opportunities, descriptions of employers, etc.) to the candidate 102 via the computer 108.

For example, the candidate 102 submits or provides candidate information 110 to the employment website entity 100 via the employment website 106. The candidate information 110 includes contact information, qualification information, and/or employment preference information of the candidate 102. For example, the contact information of the candidate information 110 includes a name, a street address, an email address, a phone number, etc. of the candidate 102. The qualification information of the candidate information 110 includes education level, attended school(s), previous employment title(s), previous place(s) of employment, performed employment task(s), skill(s), license(s), certificate(s), membership(s), etc. The employment preference information of the candidate 102 includes previous employment title(s) (e.g., UX designer, software engineer, server, etc.), preferred location(s) or region(s) of employment (e.g., a city, a state, an area code, etc.), industry(s) of interest (e.g., oil and gas, automotive, food services, etc.), employment type(s) of interest (e.g., full-time, part-time, contract, seasonal, internship, etc.), preferred income level(s), etc. In some examples, the candidate 102 provided the candidate information 110 to the employment website entity 100 upon prompting by the employment website 106. Further, in some example, the candidate information 110 is included in a candidate profile of the candidate 102 and/or corresponding document(s) (e.g., a resume, a cover letter, etc.) submitted by the candidate 102 via the employment website 106.

In the illustrated example, the candidate information 110 provided by the candidate 102 is sent to a network 112 (e.g., via a wired and/or a wireless connection). While FIG. 1 depicts the network 112 receiving the candidate information 110 from one candidate (e.g., the candidate information 110 of the candidate 102), the network 112 may receive candidate information and/or other data from a plurality of candidates (e.g., a second candidate, a third candidate, etc.). Further, as illustrated in FIG. 1, the employment website entity 100 collects the candidate information 110 from the network 112 (e.g., via a wired and/or wireless connection).

As illustrated in FIG. 1, the recruiter 104 includes an employer 114 that is, for example, a company, a corporation, and/or another entity. The employer 114 of the illustrated example is utilizing the employment website 106 of the employment website entity 100 to identify a candidate (e.g., the candidate 102) to be hired for an employment opportunity (e.g., an open position) of the employer 114. While the illustrated example includes one employer (e.g., the employer 114) in communication with the employment website entity 100, a plurality of employers may be in communication with the employment website entity 100 for identifying and/or hiring candidates for employment opportunities.

In the illustrated example, the recruiter 104 also includes an individual 116. For example, the individual 116 is an employee of the employer 114 (e.g., an employee within human resources of the employer 114) and/or a third party (e.g., a headhunter) that has been hired by the employer 114 to search for, identify, and/or hire potential candidate of interest for one or more employment opportunities with the employer 114. As illustrated in FIG. 1, the individual 116 utilizes a computer 118 (e.g., a desktop, a laptop, a mobile device such as a smart phone, a tablet, a smart watch, a wearable, etc.) to interact with the employment website 106 of the employment website entity 100. While the illustrated example includes one individual (e.g., the employer 114) of the employer 114 in communication with the employment website entity 100, the employer 114 and/or other employer(s) may include a plurality of individuals that are in communication with the employment website entity 100 for searching for, identifying, and/or hiring candidates for employment opportunities.

As illustrated in FIG. 1, the recruiter 104 (e.g., the employer 114 and/or the individual 116) provides employer information 120 to the employment website entity 100. For example, the employer information 120 includes employer information, such as a company name, a number of employees, field(s) of industry, office location(s), years of business, etc. The employer information 120 also includes information regarding an employment opportunity for which the recruiter 104 is seeking candidate(s). For example, the employment opportunity information includes an employment title, a location or region of employment, an industry, an employment type, expected tasks, preferred or required years of experience, education level(s), certificate(s), license(s), etc. Additionally, the recruiter 104 of the illustrated example receives applicant information 122 from the employment website entity 100. For example, the applicant information 122 includes one or more applications, resumes, contact information, and/or other candidate information (e.g., the candidate information 110) of candidate(s) (e.g., the candidate 102) that have submitted information to the employment website 106. As illustrated in FIG. 1, the recruiter 104 sends the employer information 120 to the employment website entity 100 via a network 124 (e.g., via a wired and/or a wireless connection), and the employment website entity 100 sends the applicant information 122 to the recruiter 104 via the network 124 (e.g., via a wired and/or a wireless connection).

Additionally, the employment website entity 100 of the illustrated example includes a candidate manager 126, a database operator 128, a candidate database 130, a query manager 132, and a search term generator 134. The candidate manager 126 receives candidate information (e.g., the candidate information 110 to candidates (e.g., the candidate 102) via the employment website 106 and presents information (e.g., the employer information 120) to candidates (e.g., the candidate 102) via the employment website 106. Further, the database operator 128 adds data to, removes data from, modifies data within, and/or otherwise organizes the data stored in the candidate database 130. For example, the database operator 128 adds an entry for each candidate (e.g., the candidate 102) that submits candidate information to the employment website entity 100 via the employment website 106. Additionally, the candidate database 130 stores data associated with candidates (e.g., the candidate 102) that have submitted information to the employment website entity 100. For example, each entry within the candidate database 130 includes an identifier and candidate information of the corresponding candidate. The query manager 132 of the illustrated example receives employment information (e.g., the employer information 120) from and/or presents applicant information (e.g., the applicant information 122) to recruiters (e.g., the recruiter 104) via the employment website 106. The query manager 132 also receives search term(s) and/or other data from recruiters (e.g., the recruiter 104), selects and/or retrieves candidate information from the candidate database 130 that is to be presented to the recruiters (e.g., the recruiter 104) based on the search term(s), and presents the applicant information 122 (e.g., including the candidate information 110 retrieved from the candidate database 130) to the recruiter 104 via the employment website 106. As disclosed in further detail below, the search term generator 134 of the illustrated example generates a search term based on a word or phrase that is highlighted by a recruiter (e.g., the recruiter 104) on the employment website 106.

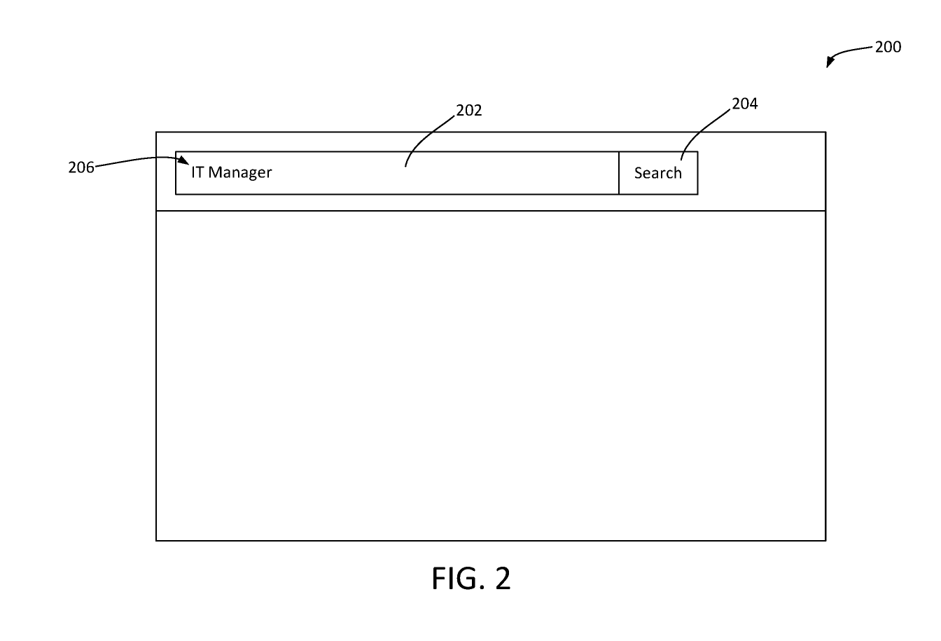

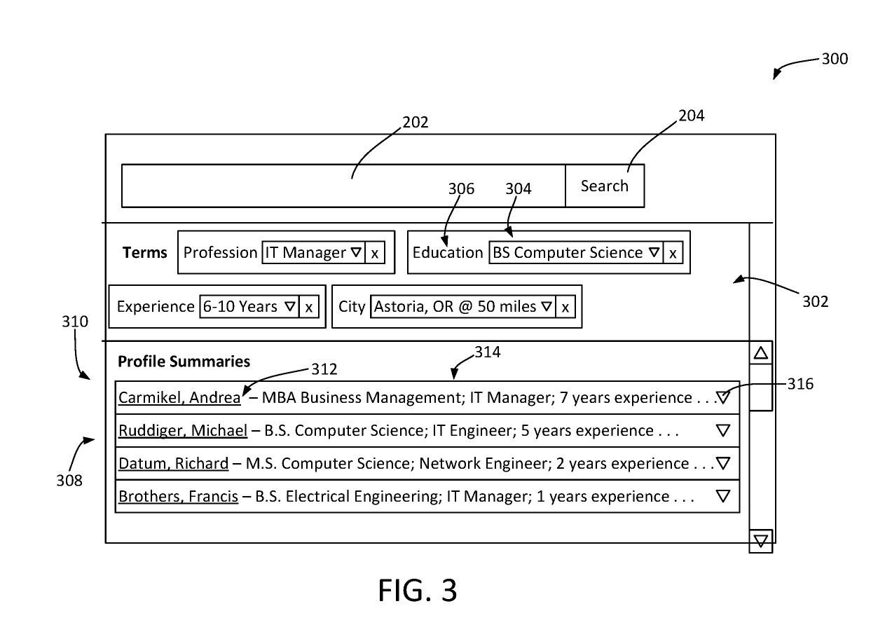

In operation, the candidate manager 126 collects the candidate information 110 from the candidate 102. The database operator 128 adds the candidate information 110 collected by the candidate manager 126 to the candidate database 130. Further, the query manager 132 receives an initial search term from the recruiter 104 via the employment website 106 (e.g., via a search box 202 of FIG. 2). Based on the initial search term, the query manager 132 retrieves candidate information from the candidate database 130 and presents the candidate information to the recruiter 104 via the employment website 106, for example, in the form of profile summaries of a list of candidates (e.g., profile summaries 310 of a list of candidates 308 of FIG. 3). In some examples, the query manager 132 presents a revised set of candidate information upon the recruiter 104 submitting other search term(s) via the employment website 106. For example, the search term generator 134 identifies a portion of the candidate information presented to the recruiter 104 via the employment website 106 that has been highlighted by the recruiter 104 on the employment website 106. Upon identifying the highlighted portion of the candidate information, the search term generator 134 automatically converts the highlighted portion into another search term. The query manager 132 modifies a search term list of the recruiter 104 to include the new search term, retrieves a revised set of candidate information from the candidate database 130 based on the updated search term list, and presents that candidate information to the recruiter 104 in the form of a revised list of candidates.

Additionally, in other examples, the query manager 132 receives an initial search term from the candidate 102 via the employment website 106 (e.g., via the search box 202). Based on the initial search term, the query manager 132 retrieves employer information from an employer database and presents the employer information to the candidate 102 via the employment website 106, for example, in the form of employer summaries of a list of employers. In some examples, the query manager 132 presents a revised set of employer information upon the candidate 102 submitting other search term(s) via the employment website 106. For example, the search term generator 134 identifies a portion of the employer information presented to the candidate 102 via the employment website 106 that has been highlighted by the candidate 102 on the employment website 106. Upon identifying the highlighted portion of the employer information, the search term generator 134 automatically converts the highlighted portion into another search term. The query manager 132 modifies a search term list of the candidate 102 to include the new search term, retrieves a revised set of employer information from the employer database based on the updated search term list, and presents that employer information to the candidate 102 in the form of a revised list of employers.

FIGS. 2-9 depict user interfaces of the employment website 106 that are presented by the query manager 132 to the recruiter 104, for example, via the computer 118 as the recruiter 104 interacts with the employment website 106.

More specifically, FIG. 2 illustrates an interface 200 (e.g., a first interface) of the employment website 106 that is initially presented to the recruiter 104, for example, upon the recruiter 104 signing onto the employment website 106. As illustrated in FIG. 2, the interface 200 includes a search box 202 and a search button 204. The search box 202 enables the recruiter 104 to enter search terms (e.g., search terms 304 of FIG. 3) that are received and utilized by the query manager 132 to search for potential candidate(s) of interest for the recruiter 104. In the illustrated example, the recruiter 104 has entered an initial search term 206 into the search box 202 to begin a search for potential candidate(s) to fill an employment opportunity. In some examples, the recruiter 104 enters the initial search term 206 into the search box 202 by moving a curser into the search box 202 and subsequently typing the word or phrase of the initial search term 206. In other examples, the recruiter 104 enters the initial search term 206 into the search box 202 by providing audible instruction(s) into a microphone (e.g., of the computer 108) that is identified via speech-recognition software. In the illustrated example, the recruiter 104 enters the initial search term 206 of “IT Manager” to identify candidates who are looking for an employment opportunity as an IT manager and/or who have identified themselves as having past and/or current experience as an IT manager. Additionally, the recruiter 104 selects the search button 204 to submit the initial search term 206 that is entered into the search box 202 as a search term.

FIG. 3 illustrates another interface 300 (e.g., a second interface) of the employment website 106. As illustrated in FIG. 3, the interface 300 displays a search term list 302 that includes one or more search terms 304 that have been submitted by the recruiter 104 (e.g., via the search box 202 and the search box 202). For example, the search terms 304 correspond to a profession, an employment title, a number of years of work experience, an education level, an educational degree, a preferred location of employment, a skill set, and/or any other characteristic (e.g., a qualification characteristic, an employment preference characteristic, etc.) that may be utilized by the query manager 132 to identify potential candidate(s) of interest for the recruiter 104. In some examples, one or more of the search terms 304 included in the interface 300 is a synonym, a related term, and/or a different grammatical structure of the term that the recruiter 104 submitted via the search box 202 and the search button 204. For example, the query manager 132 transforms a word or phrase submitted by the recruiter 104 to facilitate the identification of candidates within the candidate database 130. In other examples, the search term to be generated is (i.e., is identical to) the portion of the candidate information that is highlighted by the recruiter 104 on the employment website 106.

Additionally, the interface 300 of the illustrated example includes categories 306 that correspond to the search terms 304. For example, upon receiving one of the search terms 304 from the recruiter 104 via the employment website 106, the query manager 132 identifies and presents one of the categories 306 that corresponds to the one of the search terms 304. In the illustrated example, the search terms 304 of the search term list 302 include an “IT Manager” search term, a “BS Computer Science” search term, a “6-10 Years” search term, and an “Astoria, OR @ 50 miles” search term. Further, the categories 306 include a “Profession” category that corresponds to the “IT Manager” search term, an “Education” category that corresponds to the “BS Computer Science” search term, an “Experience” category that corresponds to the “6-10 Years” search term, and a “City” category that corresponds to the “Astoria, OR @ 50 miles” search term. The categories 306 enable the recruiter 104 to identify how the query manager 132 has interpreted the search terms 304 submitted by the recruiter 104. For example, if the recruiter 104 opposes how the query manager 132 has classified one or more of the search terms 304, the query manager 132 enables the recruiter 104 to remove, revise, and/or replace the one or more of the search terms 304 to facilitate the recruiter 104 in searching for candidate(s) of interest.

The interface 300 of the illustrated example also includes a list of candidates 308 that are determined by the query manager 132 based upon the search terms 304 of the search term list 302. In some examples, the list of candidates 308 is updated by the query manager 132 each time the recruiter 104 modifies the search term list 302 (e.g., by adding, removing, and/or revising one or more of the search terms 304). For example, the interface 300 includes an initial candidate list in response to the recruiter 104 submitting the initial search term 206. The list of candidates 308 presented in the interface 300 is revised by the query manager 132 upon the recruiter 104 entering a second of the search terms 304, is again revised by the query manager 132 upon the recruiter 104 entering a third of the search terms 304, etc.

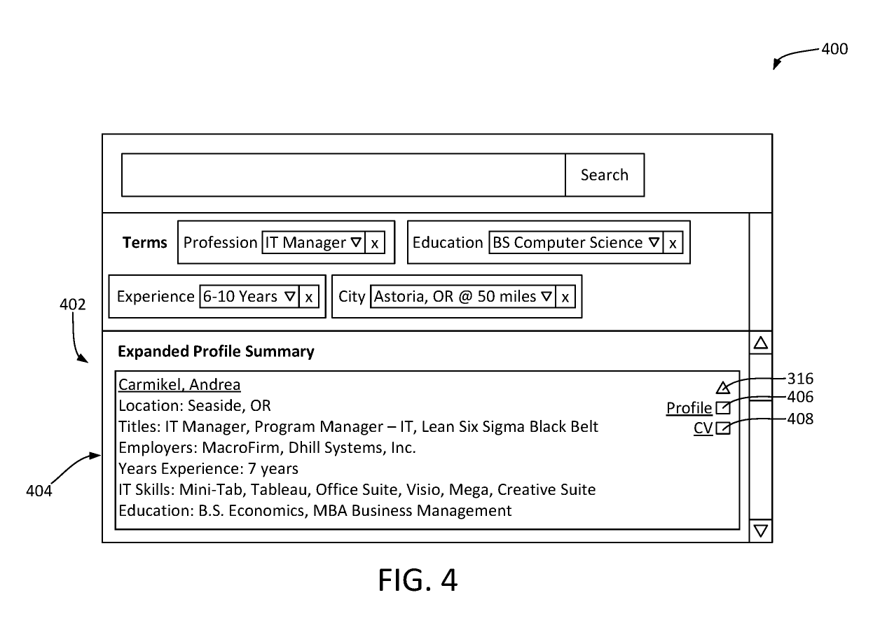

As illustrated in FIG. 3, the list of candidates 308 includes one or more profile summaries 310 of candidates that the query manager 132 has identified within the candidate database 130 based upon the search term list 302. In the illustrated example, each of the profile summaries 310 includes a candidate name 312, candidate information 314, and an expansion tab 316. For each of the profile summaries 310, the candidate name 312 identifies the corresponding candidate and the candidate information 314 includes contact information, qualification information, and/or employment preference information. For example, the candidate information includes a profession, an employment title, a number of years of work experience, an education level, an educational degree, a preferred location of employment, a skill set, and/or other information of the candidate. In the illustrated example, the candidate information 314 of each of the profile summaries 310 includes a brief overview of candidate information (e.g., the candidate information 110) that the corresponding candidate (e.g., the candidate 102) has submitted to the employment website entity 100 via the employment website 106. For example, each of the profile summaries 310 of the list of candidates 308 forms a single line of text on the interface 300 to enable the recruiter 104 to quickly review a large number of the profile summaries 310 within the list of candidates 308. Additionally or alternatively, the list of candidates 308 has a maximum threshold of candidates to limit the number of profile summaries 310 presented to the recruiter 104 within the interface 300 to a manageable number. Further, if the recruiter 104 is interested in one of the profile summaries 310 included in the list of candidates 308, the recruiter selects the expansion tab 316 of that profile summary to instruct the query manager 132 to present additional information (e.g., within an expanded profile summary 402 of FIG. 4) for that candidate via the employment website 106.

FIG. 4 illustrates another interface 400 (e.g., a third interface) of the employment website 106. The interface 400 includes an expanded profile summary 402 one of the candidates within the list of candidates 308. As illustrated in FIG. 4, the expanded profile summary 402 includes candidate information 404 corresponding to that candidate. In the illustrated example, the candidate information 404 includes an overview of candidate information (e.g., the candidate information 110) that the candidate (e.g., the candidate 102) has submitted to the employment website entity 100 via the employment website 106. For example, the candidate information 404 of the expanded profile summary 402 provides more candidate information (e.g., additional contact information, qualification information, and/or employment preference of the candidate) than the corresponding one of the profile summaries 310 and less candidate information than a profile of the candidate. For example, the employment website entity 100 has a profile of the candidate that includes a complete and/or otherwise detailed list of candidate information that the candidate has submitted to the employment website entity 100.

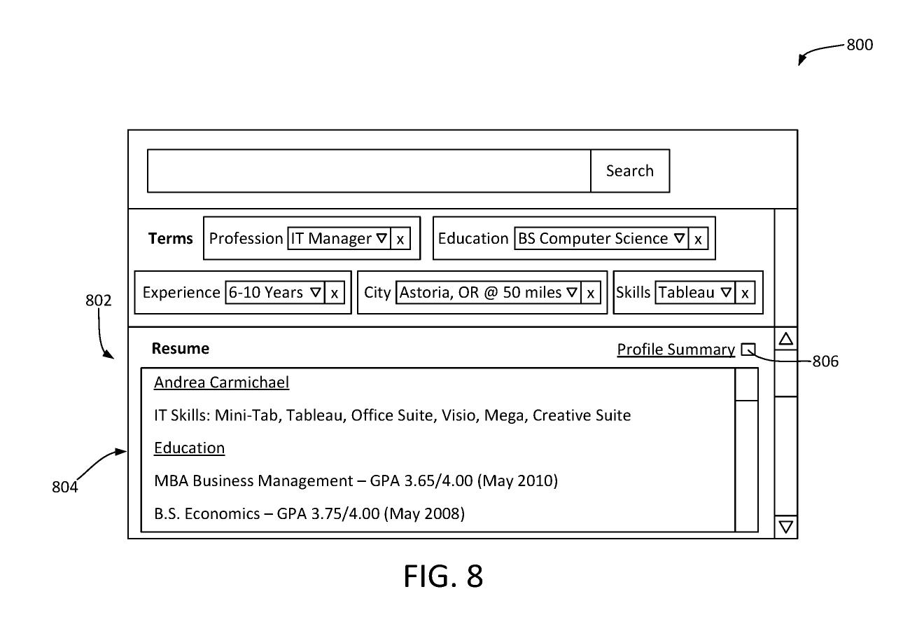

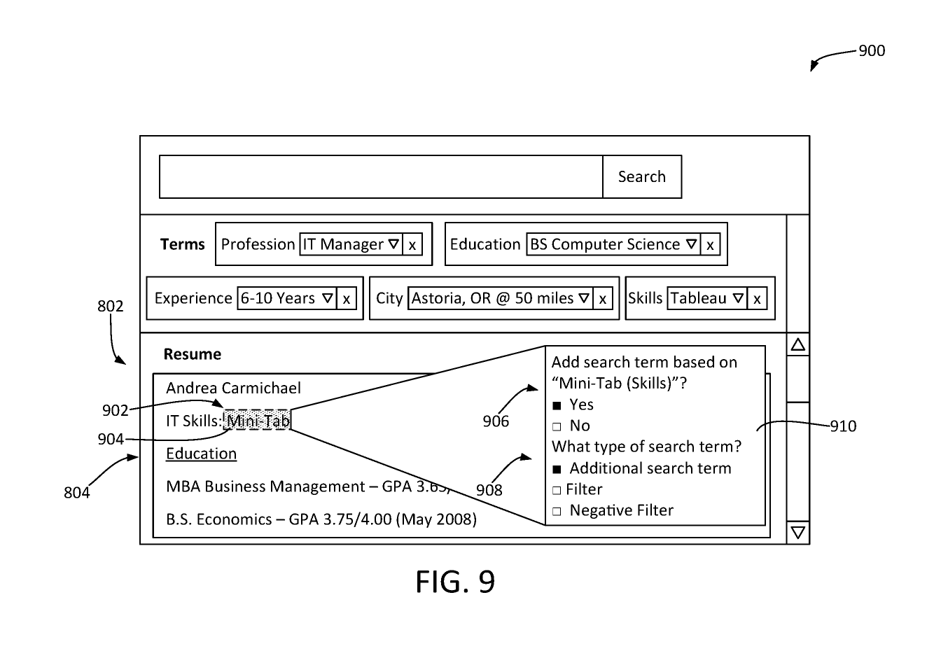

In the illustrated example, the expanded profile summary 402 includes the expansion tab 316, a profile button 406, and a resume button 408. For example, when the recruiter 104 selects the expansion tab 316 within the interface 400 of the employment website 106, the query manager 132 collapses the expanded profile summary 402 to return the employment website 106 to the interface 300 that includes the list of candidates 308. When the recruiter 104 selects the profile button 406, the employment website 106 presents the profile of the corresponding candidate to the recruiter 104. When the recruiter 104 selects the resume button 408, the employment website 106 presents a resume (e.g., a resume 802 of FIGS. 8-9) of the corresponding candidate to the recruiter 104. Additionally, the recruiter 104 may select a word or phrase of text presented within the candidate information 404 of the expanded profile summary 402 (e.g., a portion 502 of the candidate information 404) to generate a new search term that the query manager 132 is to add to the search terms 304 of the search term list 302.

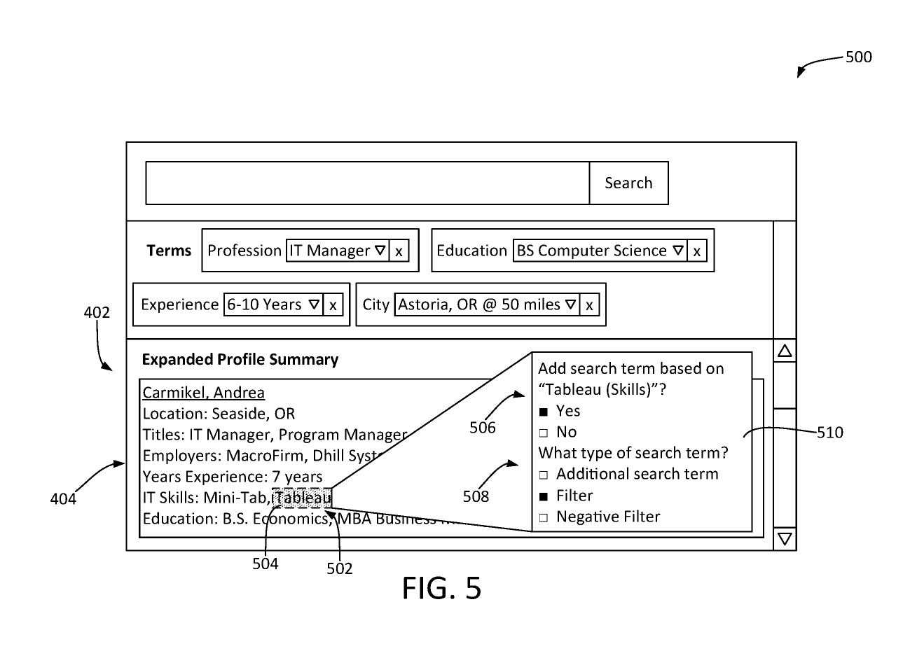

FIG. 5 illustrates another interface 500 (e.g., a fourth interface) of the employment website 106 in which the recruiter 104 has highlighted a portion 502 of the candidate information 404 within the expanded profile summary 402. In the illustrated example, the portion 502 includes highlighted text 504 of the candidate information 404. For example, the portion 502 of the candidate information 404 that is highlighted by the recruiter 104 on the employment website 106 via code within a markup language (e.g., hypertext markup language (HTML), extensible markup language (XML), extendible hypertext markup language (XHTML), etc.) that is utilized to develop, maintain, and process the employment website 106.

As illustrated in FIG. 5, in response to the recruiter 104 highlighting the portion 502 of the candidate information 404, search-term confirmation buttons 506 and search-type selection buttons 508 are presented within the interface 500 of the employment website 106. In the illustrated example, the search-term confirmation buttons 506 and the search-type selection buttons 508 are included within a modal window 510 (e.g., a pop-up window) that appears within the interface 500 after the recruiter 104 highlights the portion 502. In other examples, the search-term confirmation buttons 506 and the search-type selection buttons 508 are presented within other portion(s) of the interface 500.

In the illustrated example, the search-term confirmation buttons 506 indicate the search term (“Tableau”) and the corresponding category (“Skills”) that is to be generated based upon the portion 502 of the candidate information 404 that has been highlighted by the recruiter 104. The recruiter 104 selects the “Yes” button to confirm that a search term is to be generated based upon the portion 502 of the candidate information 404 that is highlighted or selects the “No” button to indicate that a search term is not to be generated based upon the portion 502 (e.g., if the portion 502 was unintentionally highlighted).

Additionally, upon selecting the “Yes” button of the search-term confirmation buttons 506, the recruiter 104 is to select which type of search term is to be generated via the search-type selection buttons 508. For example, the recruiter 104 selects the “Additional search term” button to create an additional search term based upon the portion 502 of the candidate information 404 that is highlighted. An additional search term (i.e., a logical disjunction, an “or” operator) enables the query manager 132 to select an entry (e.g., a candidate identifier and corresponding candidate information) from the candidate database 130 that includes the additional search term or, alternatively, another of the search terms 304 included in the search term list 302. The recruiter 104 selects the “Filter” button to create a filter based upon the portion 502 of the candidate information 404 that is highlighted. A filter (i.e., a logical conjunction, an “and” operator) requires that any entry selected from the candidate database 130 by the query manager 132 includes the filter. The recruiter 104 selects the “Negative Filter” button to create a negative filter based upon the portion 502 of the candidate information 404 that is highlighted. A negative filter (i.e., a logical negation, a “not” operator) requires that any entry selected from the candidate database 130 by the query manager 132 does not include the negative filter. Once the recruiter 104 selects the search term type via the search-type selection buttons 508, the search term generator 134 generates the search term based upon the portion 502 of the candidate information 404 that is highlighted and subsequently adds the new search term to the search terms 304 of the search term list 302. The search term generator 134 automatically generates the new search term based upon the portion 502 of the candidate information 404 that has been highlighted on the employment website 106 by the recruiter 104 to enable the recruiter 104 to quickly and intuitively revise the search term list 302 that is utilized in searching for candidates of interest.

Further, while FIG. 5 depicts the search term generator 134 generating a search term based upon a highlighted portion of the candidate information 404 of the expanded profile summary 402, the search term generator 134 also is capable of generating a search term based upon a highlighted portion of the candidate information 314 of the list of candidates 308 of FIG. 3.

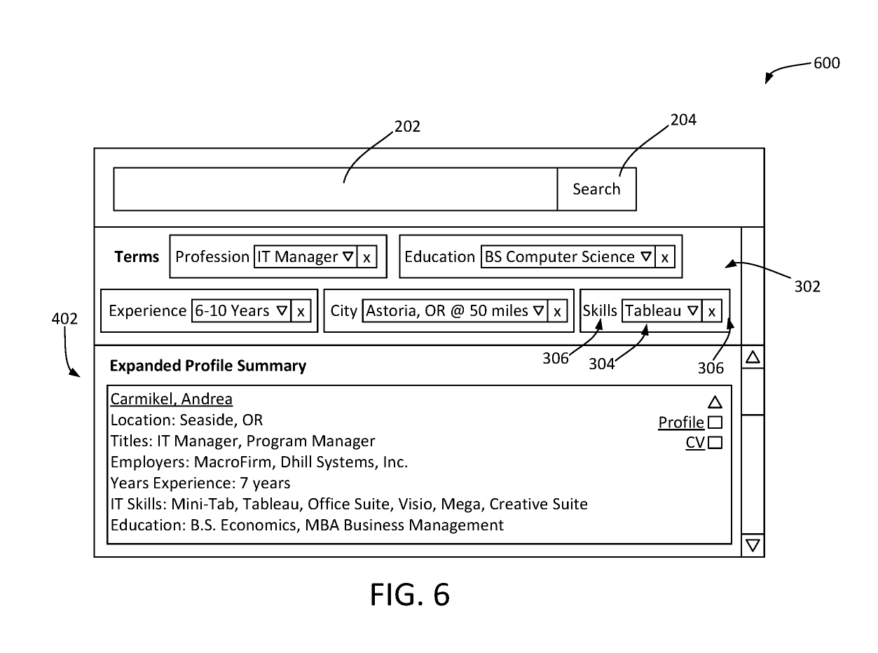

FIG. 6 illustrates another interface 600 (e.g., a fifth interface) of the employment website 106. In the illustrated example, the search term list 302 includes the new search term that the search term generator 134 generated based upon the portion 502 of the candidate information 404 that was highlighted by the recruiter 104. As illustrated in FIG. 6, one of the search terms 304 is a “Tableau” search term, and the corresponding one of the categories 306 is a “Skills” category. Additionally or alternatively, the recruiter 104 may add other search term(s) to the search term list 302 via the search box 202. After the recruiter 104 revises the search term list 302, the recruiter 104 is capable of causing the query manager 132 to update the list of candidates 308 by selecting the search button 204.

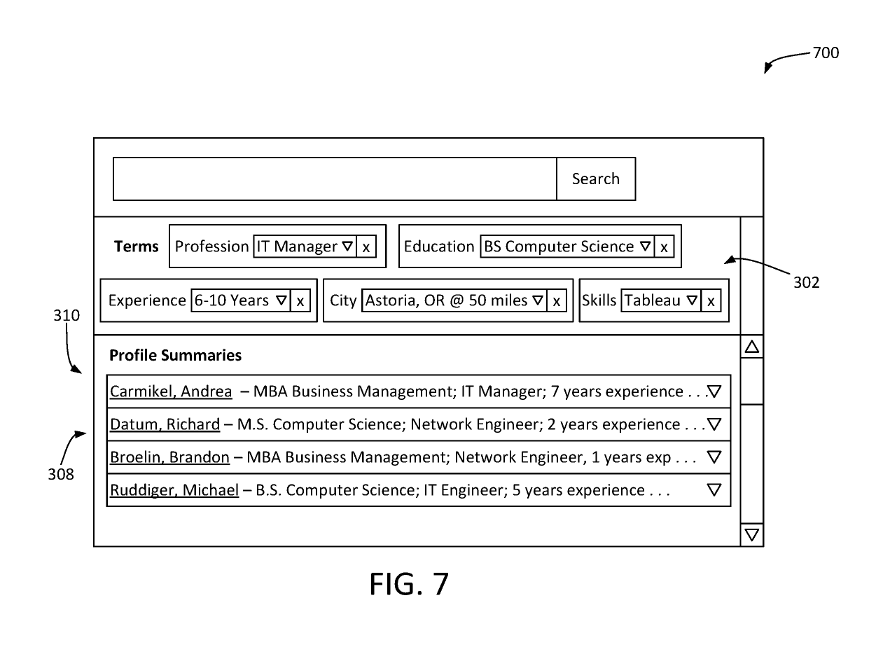

FIG. 7 illustrates another interface 700 (e.g., a sixth interface) of the employment website 106. In the illustrated example, the list of candidates 308 has been revised to include a different set of the profile summaries 310 that are identified by the query manager 132 based upon the search term list 302 that was updated to include the search term generated from the highlighted text 504.

FIG. 8 illustrates another interface 800 (e.g., a seventh interface) of the employment website 106. In the illustrated example, the interface 800 includes a resume 802 of a candidate. The resume 802 is presented via the employment website 106 in response to the recruiter 104 selecting the resume button 408 presented within the interface 400. As illustrated in FIG. 8, the resume 802 includes candidate information 804 (e.g., contact information, qualification information, and/or employment preference) corresponding to the candidate. For example, the resume 802 that is presented to the recruiter 104 via the employment website 106 is previously received from the candidate via the employment website 106. The interface 800 also includes a profile summary button 806. For example, when the recruiter 104 selects the profile summary button 806 within the interface 800 of the employment website 106, the query manager 132 returns the employment website 106 to the interface 400 that includes the expanded profile summary 402 of the candidate. Further, while FIG. 8 depicts the resume 802 being presented via the employment website 106 in response to the recruiter 104 selecting the resume button 408 of the interface 400, the query manager 132 also is capable of presenting a profile of a candidate via the employment website 106 in response to the recruiter 104 selecting the profile button 406 of the interface 400.

FIG. 9 illustrates another interface 900 (e.g., an eighth interface) of the employment website 106 in which the recruiter 104 has highlighted a portion 902 of the candidate information 804 within the resume 802. In the illustrated example, the portion 902 includes highlighted text 904 of the candidate information 804. Additionally, search-term confirmation buttons 906 and search-type selection buttons 908 are presented within the interface 900 in response to the recruiter 104 highlighting the portion 902 of the candidate information 804. In the illustrated example, the search-term confirmation buttons 906 and the search-type selection buttons 908 are included within a modal window 910 (e.g., a pop-up window) that appears within the interface 900 after the recruiter 104 highlights the portion 902. In other examples, the search-term confirmation buttons 906 and the search-type selection buttons 908 are presented within other portion(s) of the interface 900.

In the illustrated example, the search-term confirmation buttons 906 indicate the search term (“Mini-Tab”) and the corresponding category (“Skills”) that is to be generated based upon the portion 902 of the candidate information 804 that has been highlighted by the recruiter 104. The recruiter 104 selects the “Yes” button to confirm that a search term is to be generated based upon the portion 902 of the candidate information 804 that is highlighted or selects the “No” button to indicate that a search term is not to be generated based upon the portion 902. Additionally, upon selecting the “Yes” button of the search-term confirmation buttons 906, the recruiter 104 is to select which type of search term is to be generated via the search-type selection buttons 908. For example, the recruiter 104 selects the “Additional search term” button to create an additional search term, the “Filter” button to create a filter, or the “Negative Filter” button to create a negative filter based upon the portion 902 of the candidate information 804 that is highlighted. Once the recruiter 104 selects the search term type via the search-type selection buttons 508, the search term generator 134 generates the search term based upon the portion 902 of the candidate information 804 that is highlighted and subsequently adds the new search term to the search terms 304 of the search term list 302. The search term generator 134 automatically generates the new search term based upon the portion 902 of the candidate information 484 that has been highlighted on the employment website 106 by the recruiter 104 to enable the recruiter 104 to quickly and intuitively revise the search term list 302 that is utilized in searching for candidates of interest.

Further, while FIG. 9 depicts the search term generator 134 generating a search term based upon a highlighted portion of the candidate information 804 of the resume 802, the search term generator 134 also is capable of generating a search term based upon a highlighted portion of candidate information that is included in a profile of a candidate presented to the recruiter 104 via the employment website 106.

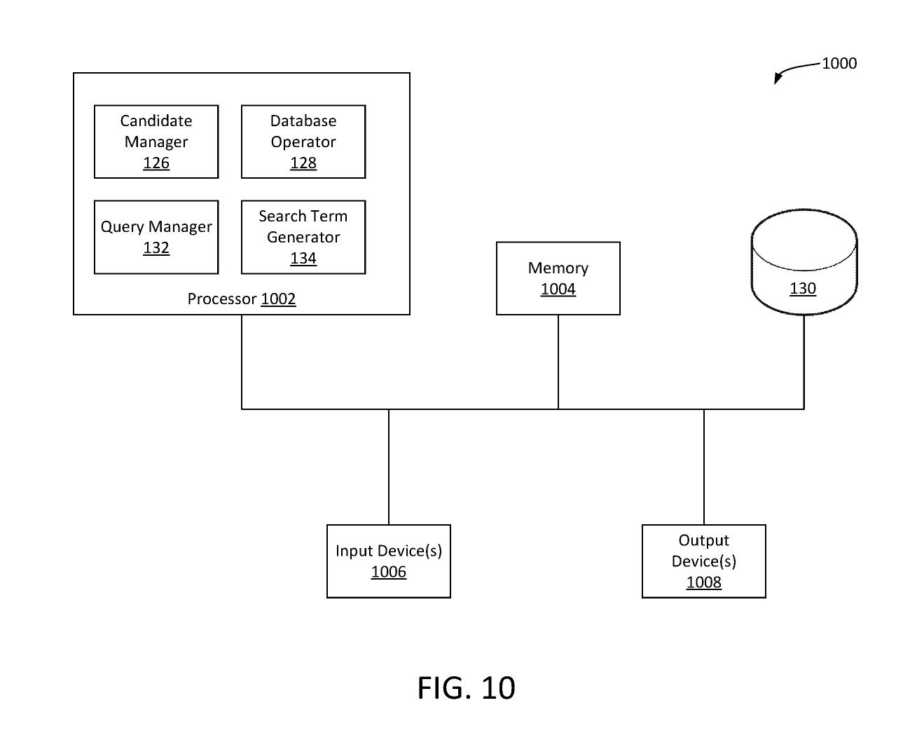

FIG. 10 is a block diagram of electronic components 1000 of the employment website entity 100. As illustrated in FIG. 10, the electronic components 1000 include a microcontroller unit, controller or processor 1002. Further, the electronic components 1000 include memory 1004, the candidate database 130, input device(s) 1006, and output device(s) 1008.

In the illustrated example, the processor 1002 is structured to include the candidate manager 126, the database operator 128, the query manager 132, and the search term generator 134. The processor 1002 of the illustrated example is any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). In some examples, the memory 1004 is volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). Further, in some examples, the memory 1004 includes multiple kinds of memory, particularly volatile memory and non-volatile memory.

The memory 1004 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 1004, the computer readable medium, and/or within the processor 1002 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the input device(s) 1006 enable a user, such as an information technician of the employment website entity 100, to provide instructions, commands, and/or data to the processor 1002. Examples of the input device(s) 1006 include one or more of a button, a control knob, an instrument panel, a touch screen, a touchpad, a keyboard, a mouse, a speech recognition system, etc.

The output device(s) 1008 of the illustrated example display output information and/or data of the processor 1002 to a user, such as an information technician of the employment website entity 100. Examples of the output device(s) 1008 include a liquid crystal display (LCD), an organic light emitting diode (OLED) display, a flat panel display, a solid state display, and/or any other device that visually presents information to a user. Additionally or alternatively, the output device(s) 1008 may include one or more speakers and/or any other device(s) that provide audio signals for a user. Further, the output device(s) 1008 may provide other types of output information, such as haptic signals.

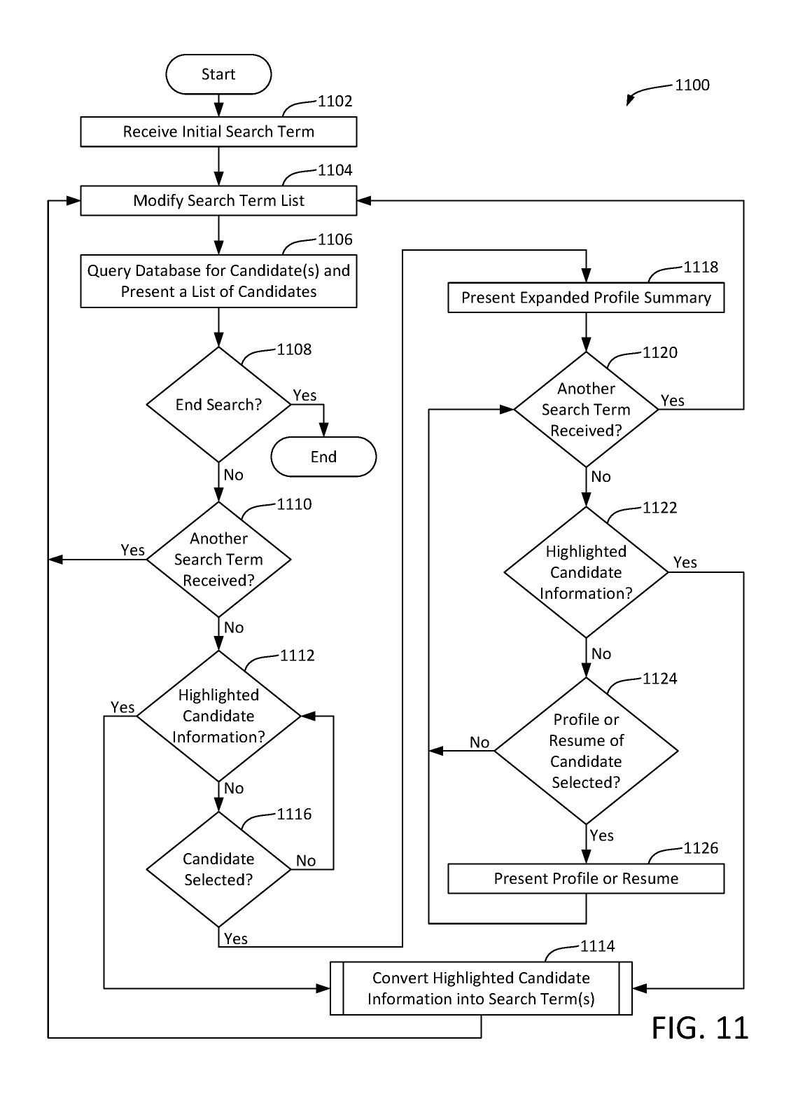

FIG. 11 is a flowchart of example method 1100 for modifying a query based on candidate information that is highlighted by a recruiter on an employment website. The flowchart of FIG. 11 is representative of machine readable instructions that are stored in memory (such as the memory 1004 of FIG. 10) and include one or more programs which, when executed by a processor (such as the processor 1002 of FIG. 10), cause the employment website entity 100 to implement the example query manager 132 and/or the example search term generator 134 of FIGS. 1 and 10. While the example program is described with reference to the flowchart illustrated in FIG. 11, many other methods of implementing the example query manager 132 and/or the example search term generator 134 may alternatively be used. For example, the order of execution of the blocks may be rearranged, changed, eliminated, and/or combined to perform the method 1100. Additionally, while the method 1100 of FIG. 11 describes a method for modifying a query based on candidate information that is highlighted by a recruiter on an employment website, one or more blocks of the method 1100 may be rearranged, changed, eliminated, and/or combined to enable the method 1100 to be executed as a method for modifying a query based on employer and/or other information that is highlighted by a candidate and/or other person on an employment and/or other website. Further, because the method 1100 is disclosed in connection with the components of FIGS. 1-10, some functions of those components will not be described in detail below.

Initially, at block 1102, the query manager 132 receives the initial search term 206 from the recruiter 104 via the employment website 106. For example, the query manager 132 receives the initial search term 206 upon the recruiter 104 entering the initial search term 206 into the search box 202 and subsequently selecting the search button 204 of the employment website 106. In some examples, the recruiter 104 types the initial search term 206 into the search box 202. In other examples, the initial search term 206 is entered into the search box 202 via speech-recognition software that identifies the initial search term 206 based upon an audio signal the recruiter provides into a microphone of the computer 108. At block 1104, the query manager 132 modifies the search term list 302 to include the initial search term 206 in real time during the session of the recruiter 104 on the employment website 106. For example, the query manager 132 modifies the search term list 302 by adding the initial search term 206 to the search term list 302.

At block 1106, the query manager 132 queries the candidate database 130 in real time during the session of the recruiter 104 on the employment website 106 to identify the list of candidates 308 based on the search term list 302. For example, the query manager 132 queries the candidate database 130 to identify which candidates within the candidate database 130 include candidate information that corresponds to the search term(s) (e.g., the initial search term 206, FIG. 2, one or more of the search terms 304 of FIGS. 3-9) of the search term list 302. In some examples, the query manager 132 ranks the candidates identified as corresponding to the search term list 302 to identify the candidates that most closely match to the search terms 304 of the search term list 302. In some examples, the list of candidates 308 has a maximum threshold of candidates such that the query manager 132 includes a number of candidates in the list of candidates 308 that is less than or equal to the maximum threshold. Further, the query manager 132 presents the list of candidates 308 and the candidate information 314 included in the list of candidates 308 to the recruiter 104 via the employment website 106 during the session of the recruiter 104 on the employment website 106. For example, the query manager 132 identifies an initial list of candidates based on the initial search term 206 and presents the initial list of candidates that includes candidate information for each candidate within the initial list of candidates.

At block 1108, the query manager 132 determines whether the recruiter 104 has ended the search. For example, the recruiter 104 terminates the search by signing out of and/or otherwise exiting the employment website 106. In response to the query manager 132 determining that the search has ended, the method 1100 ends. Otherwise, in response to the query manager 132 determining that the search has not ended, the method 1100 proceeds to block 1110.

At block 1110, the query manager 132 determines whether another search term has been received from the recruiter 104 via the employment website 106. For example, the search box 202 and the search button 204 enable the query manager 132 to receive another search terms throughout the session of the recruiter 104 on the employment website 106. In response to the query manager 132 determining that another search term has been received, the method 1100 returns to block 1104 and repeats blocks 1104, 1106, 1108 to identify the other search term, modify the search term list 302 to include the other search term, re-query the candidate database 130 for the list of candidates 308 based upon the search term list 302 that is modified, and present the updated list of candidates 308 to the recruiter 104 via the employment website 106. Otherwise, in response to the query manager 132 determining that another search term has not been received, the method 1100 proceeds to block 1112.

At block 1112, the query manager 132 determines whether a portion of the candidate information 314 included in the list of candidates 308 has been highlighted by the recruiter 104 on the employment website 106. For example, the recruiter 104 highlights the portion of the candidate information 314 to initiate a search term being generated based upon a word or phrase of the portion of the candidate information 314. In response to the query manager 132 determining that a portion of the candidate information 314 included in the list of candidates 308 has been highlighted, the method 1100 proceeds to block 1114.

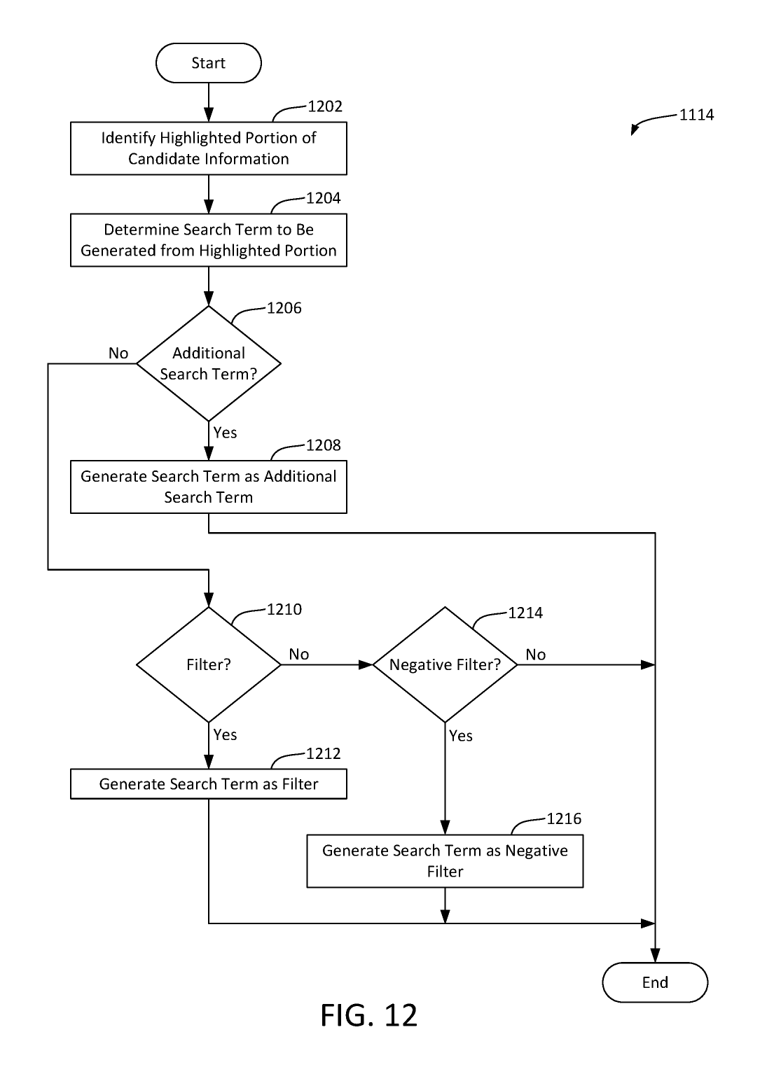

At block 1114, the search term generator 134 automatically converts the highlighted portion of the candidate information 314 into a search term (e.g., one of the search terms 304 of FIG. 3, a first search term, a second search term, etc.) responsive to the recruiter 104 highlighting the portion of the candidate information 314. For example, as disclosed in further detail below with respect to FIG. 12, the search term generator 134 identifies the portion of the candidate information 314 that has been highlighted by the recruiter 104 on the employment website 106, determines the search term (e.g., one of the search terms 304) that is to be generated based upon the portion that has been highlighted, identifies a type of search term (e.g., as an additional search term, a filter, a negative filter) that has been selected by the recruiter 104, and subsequently generates the search term based upon the portion that has been highlighted and the type of search term that has been selected. Upon completing block 1114, the method 1100 returns to block 1104 to enable to the query manager 132 to modify the search term list 302 by adding the newly generated search term to the search term list 302. The search term generator 134 automatically generates the search term based upon the portion of the candidate information 314 that has been highlighted on the employment website 106 by the recruiter 104 to enable the recruiter 104 to quickly and intuitively revise the search term list 302 that is utilized in searching for candidates of interest.

Otherwise, in response to the query manager 132 determining that a portion of the candidate information 314 included in the list of candidates 308 has not been highlighted, the method 1100 proceeds to block 1116 at which the query manager 132 determines whether candidate(s) from the list of candidates 308 has been selected by the recruiter 104 on the employment website 106. For example, the query manager 132 determines that the recruiter 104 has selected a candidate from the list of candidates 308 upon detecting that the recruiter 104 has selected the expansion tab 316 included in one of the profile summaries 310 that correspond to the candidate. In response to the query manager 132 determining that a candidate has not been selected by the recruiter 104, the method 1100 returns to block 1112. Otherwise, in response to the query manager 132 determining that a candidate has been selected by the recruiter 104, the method 1100 proceeds to block 1118 at which the query manager 132 presents the expanded profile summary 402 of the selected candidate to the recruiter 104 via the employment website 106. For example, the expanded profile summary 402 includes the candidate information that may be highlighted by the recruiter 104 in real time during the session on the employment website 106.

At block 1120, the query manager 132 determines whether the query manager 132 has received another search term from the recruiter 104 via the search box 202 and the search button 204 of the employment website 106. In response to determining that the query manager 132 has received another search term via the search box 202 and the search button 204, the method returns to block 1104 to enable to the query manager 132 to modify the search term list 302 by adding the other search term to the search term list 302. Otherwise, in response to determining that the query manager 132 has not received another search term via the search box 202 and the search button 204, the method proceeds to block 1122.

At block 1122, the query manager 132 determines whether a portion of candidate information has been highlighted by the recruiter 104 on the employment website 106. For example, when the employment website 106 is presenting the expanded profile summary 402, the query manager 132 determines whether a portion (e.g., the portion 502 of FIG. 5) of the candidate information 404 included in the expanded profile summary 402 has been highlighted by the recruiter 104. In response to the query manager 132 determining that a portion of candidate information presented via the employment website 106 has been highlighted, the method 1100 proceeds to block 1114 at which the search term generator 134 automatically converts the highlighted portion of candidate information into a search term (e.g., one of the search terms 304 of FIG. 3, a first search term, a second search term, etc.). The search term generator 134 automatically generates the search term based upon a portion of candidate information that has been highlighted on the employment website 106 by the recruiter 104 to enable the recruiter 104 to quickly and intuitively revise the search term list 302 that is utilized in searching for candidates of interest. Otherwise, in response to the query manager 132 determining that a portion of candidate information presented via the employment website 106 has not been highlighted, the method 1100 proceeds to block 1124.

At block 1124, the query manager 132 determines whether the profile or the resume 802 of the candidate has been selected by the recruiter 104 on the employment website 106. For example, the query manager 132 determines that the recruiter 104 has selected the profile of the candidate upon detecting that the recruiter 104 has selected the profile button 406 on the employment website 106. The query manager 132 determines that the recruiter 104 has selected the resume 802 of the candidate upon detecting that the recruiter 104 has selected the resume button 408 on the employment website 106. In response to the query manager 132 determining that the recruiter 104 has not selected the profile or the resume 802 of the candidate, the method 1100 returns to block 1120. Otherwise, in response to the query manager 132 determining that the recruiter 104 has selected the profile or the resume 802 of the candidate, the method 1100 proceeds to block 1126.

At block 1126, the query manager 132 presents the profile or the resume 802 of the selected candidate. For example, the query manager 132 presents the profile of the candidate at block 1126 if the profile is selected at block 1124 or presents the resume 802 of the candidate at block 1126 if the resume 802 is selected at block 1124. In some examples, prior to the query manager 132 presenting the resume 802, the candidate manager 126 retrieves the resume 802 from the candidate (e.g., the candidate 102 of FIG. 1) via the employment website 106, parses the resume 802 to facilitate the selection of portions of the resume 802 for generation of corresponding search terms. Further, in some such examples, the database operator 128 stores the resume 802 that is parsed in the candidate database 130 to enable the query manager 132 to retrieve the resume 802 that is parsed upon the recruiter 104 selecting the resume button 408.

Upon completing block 1126, the method 1100 returns to block 1120 to enable the query manager 132 to determine whether the search term generator 134 is to generate a new search term based upon a portion of candidate information included in the profile or the resume 802 has been highlighted by the recruiter 104. For example, when the employment website 106 is presenting the resume 802 of the selected candidate, the query manager 132 determines, at block 1122, whether a portion (e.g., the portion 902 of FIG. 9) of the candidate information 804 included in the resume 802 has been highlighted by the recruiter 104. Further, when the employment website 106 is presenting the profile of the selected candidate, the query manager 132 determines, at block 1122, whether a portion of candidate information included in the profile has been highlighted by the recruiter 104. Further, in some examples, the method 1100 returns to block 1118 upon the query manager 132 determining that the recruiter 104 has selected another candidate from the list of candidates 308 on the employment website 106.

FIG. 12 is a flowchart of example method 1114 to perform the block 1114 of FIG. 11 to generate a search term based on highlighted candidate information. The flowchart of FIG. 12 is representative of machine readable instructions that are stored in memory (such as the memory 1004 of FIG. 10) and include one or more programs which, when executed by a processor (such as the processor 1002 of FIG. 10), cause the employment website entity 100 to implement the example search term generator 134 of FIGS. 1 and 10. While the example program is described with reference to the flowchart illustrated in FIG. 12, many other methods of implementing the example search term generator 134 may alternatively be used. For example, the order of execution of the blocks may be rearranged, changed, eliminated, and/or combined to perform the method 1114. Additionally, while the method 1114 of FIG. 11 describes a method for generating a search term based on highlighted candidate information, one or more blocks of the method 1114 may be rearranged, changed, eliminated, and/or combined to enable the method 1114 to be executed as a method for generating a search term based on highlighted employer and/or other information. Further, because the method 1114 is disclosed in connection with the components of FIGS. 1-10, some functions of those components will not be described in detail below.

Initially, at block 1202, the search term generator 134 identifies the portion (e.g., the portion 502 of FIG. 5, the portion 902 of FIG. 9) of the candidate information (e.g., the candidate information 314 of FIG. 3, the candidate information 404 of FIGS. 4-5, the candidate information 804 of FIGS. 8-9) that has been highlighted by the recruiter 104 on the employment website 106. For example, the search term generator 134 a word or phrase of text that has been highlighted by the recruiter 104 on the employment website 106. In some examples, the highlighted portion of the candidate information includes a profession, an employment title, a number of years of work experience, an education level, an educational degree, a preferred location of employment, a skill set, and/or any other characteristic that may be utilized as a search term to identify potential candidate(s) of interest for an employment opportunity.

At block 1204, the search term generator 134 determines the search term (e.g., one of the search terms 304 of FIGS. 3-9) that is to be generated based upon the highlighted portion of the candidate information. In some examples, the search term generator 134 converts the highlighted portion into a synonym, a related term, and/or a different grammatical structure of the highlighted portion for generating the search term. In other examples, the search term to be generated is (i.e., is identical to) the portion of the candidate information that is highlighted by the recruiter 104 on the employment website 106.

At block 1206, the search term generator 134 determines whether the search term is to be an additional search term (i.e., a logical disjunction, an “or” operator). For example, the search term generator 134 determines that the search term is to be an additional search term upon detecting that the recruiter 104 has selected an “additional search term” box within the search-type selection buttons 508. In response to the search term generator 134 determining that the search term is to be an additional search term, the method 1114 proceeds to block 1208 at which the search term generator 134 generates the new search term that is based upon the highlighted portion of the candidate information as an additional search term. Otherwise, in response to the search term generator 134 determining that the search term is not to be an additional search term, the method 1114 proceeds to block 1210.

At block 1210, the search term generator 134 determines whether the search term is to be a filter (e.g., a logical conjunction, an “and” operator). For example, the search term generator 134 determines that the search term is to be a filter upon detecting that the recruiter 104 has selected a “filter” box within the search-type selection buttons 508. In response to the search term generator 134 determining that the search term is to be a filter, the method 1114 proceeds to block 1212 at which the search term generator 134 generates the new search term that is based upon the highlighted portion of the candidate information as a filter. Otherwise, in response to the search term generator 134 determining that the search term is not to be a filter, the method 1114 proceeds to block 1214.

At block 1214, the search term generator 134 determines whether the search term is to be a negative filter (e.g., a logical negation, a “not” operator). For example, the search term generator 134 determines that the search term is to be a negative filter upon detecting that the recruiter 104 has selected a “negative filter” box within the search-type selection buttons 508. In response to the search term generator 134 determining that the search term is to be a negative filter, the method 1114 proceeds to block 1216 at which the search term generator 134 generates the new search term that is based upon the highlighted portion of the candidate information as a negative filter. Otherwise, in response to the search term generator 134 determining that the search term is not to be a negative filter, the method 1114 ends.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for adjusting search queries for candidates on employment websites, the system comprising:
a query manager to:
present, via a processor, candidate information to a recruiter based on a search term list during a session on an employment website;
modify, in real time during the session, the search term list to include a first search term selected by the recruiter;
query, in real time during the session, a database for a list of candidates based on the search term list that is modified; and
present the list of candidates on the employment website during the session; and
a search term generator to:
identify a first portion of the candidate information that has been highlighted by the recruiter on the employment website; and
automatically convert the first portion of the candidate information into the first search term responsive to the recruiter highlighting the first portion.

2. The system of claim 1, wherein the first portion of the candidate information includes at least one of a profession, an employment title, a number of years of work experience, an education level, an educational degree, a location, and a skill set of the candidate.

3. The system of claim 1, wherein the first search term automatically generated by the search term generator is the first portion of the candidate information that is highlighted.

4. The system of claim 1, wherein the search term generator convert the first portion of the candidate information to at least one of a synonym, a related term, and a different grammatical structure of the first portion to generate the first search term.

5. The system of claim 1, wherein:
the search term generator is to:
identify a second portion of the candidate information that has been highlighted by the recruiter during the session; and
automatically convert the second portion of the candidate information into a second search term responsive to the recruiter highlighting the second portion; and
the query manager is to modify, in real time during the session, the search term list to include the second search term selected by the recruiter.

6. The system of claim 1, wherein the candidate information presented by the query manager is included in an initial list of candidates that the query manager identifies based on an initial search term of the search term list.

7. The system of claim 6, wherein the query manager is to receive the initial search term from the recruiter via a search box of the employment website.

8. The system of claim 7, wherein the search box enables the query manager to receive other search terms throughout the session.

9. The system of claim 6, wherein the initial list of candidates presented by the query manager includes the first portion highlighted by the recruiter.

10. The system of claim 1, wherein the candidate information presented by the query manager is included in an expanded profile summary of a candidate.

11. The system of claim 10, wherein the expanded profile summary presented by the query manager includes the first portion highlighted by the recruiter.

12. The system of claim 10, wherein the query manager is to:
include a first link to a profile of the candidate in the expanded profile summary; and
present the profile responsive to the recruiter selecting the first link, the profile including the first portion highlighted by the recruiter.

13. The system of claim 10, wherein the query manager is to:
include a second link to a resume of the candidate in the expanded profile summary; and
present the resume responsive to the recruiter selecting the second link, the resume including the first portion highlighted by the recruiter.

14. The system of claim 13, further including a candidate manager to:
retrieve a resume from the candidate;
parse the resume to facilitate selection of portions of the resume as search terms; and
store the resume that is parsed in the database.

15. The system of claim 1, wherein the query manager receives a selection that the first search term is a logical disjunction for including candidates that correspond to the first search term in the list of candidates, a logical conjunction for including candidates that correspond to both the first search term and other search terms in the list of candidates, or a logical negation for excluding candidates that correspond to the first search term from the list of candidates.

16. A method for adjusting search queries for candidates on employment websites, the method comprising:
presenting, via a processor, candidate information to a recruiter based on a search term list during a session on an employment website;
identifying, via the processor, a first portion of the candidate information responsive to the recruiter highlighting the first portion on the employment website;
automatically converting, via the processor, the first portion of the candidate information that has been highlighted by the recruiter into a first search term;
modifying, in real time during the session, the search term list to include the first search term;
querying, in real time during the session, a database for a list of candidates based on the search term list that is modified; and
presenting the list of candidates on the employment website during the session.

17. The method of claim 16, wherein the candidate information is included in at least one of an initial list of candidates, an expanded candidate summary, a candidate profile, and a candidate resume.

18. The method of claim 16, further including:
identifying a second portion of the candidate information that has been highlighted by the recruiter during the session; and
automatically converting the second portion of the candidate information into a second search term responsive to the recruiter highlighting the second portion; and
modifying, in real time during the session, the search term list to include the second search term selected by the recruiter.

19. The method of claim 16, further including:
receiving an initial search term from the recruiter via a search box of the employment website; and
presenting an initial list of candidates based on the initial search term, the initial list of candidates including the candidate information.

20. A tangible computer readable medium including instructions which, when executed, cause a machine to:
present candidate information to a recruiter based on a search term list during a session on an employment website;
identify a first portion of the candidate information responsive to the recruiter highlighting the first portion on the employment website;
automatically convert the first portion of the candidate information that has been highlighted by the recruiter into a first search term;
modify, in real time during the session, the search term list to include the first search term;
query, in real time during the session, a database for a list of candidates based on the search term list that is modified; and
present the list of candidates on the employment website during the session.
